(19) United States
(12) Patent Application Publication
(10) Pub. No.: US 2024/0322306 A1
(43) Pub. Date: Sep. 26, 2024

(54) Encapsulated Battery Cell and Battery Cell Arrangement

(71) Applicant: Volocopter GmbH, Bruchsal (DE)

(72) Inventors: Pablo Gutiérrez González, Heidelberg (DE); Chanti Charb, Augsburg (DE)

(73) Assignee: Volocopter GmbH, Bruchsal, BW (DE)

(21) Appl. No.: 18/428,148

(22) Filed: Jan. 31, 2024

(30) Foreign Application Priority Data
Mar. 22, 2023 (EP) EP23163590.5

(51) Int. Cl. H01M 50/122; H01M 10/617; H01M 10/653; H01M 10/658; H01M 50/107; H01M 50/30

(52) U.S. Cl. CPC H01M 50/122; H01M 10/617; H01M 10/653; H01M 10/658; H01M 50/107; H01M 50/30

(57) ABSTRACT

An encapsulated battery cell and a battery cell arrangement are disclosed herein. In one example, an encapsulated battery cell is disclosed including a battery cell of cylindrical shape, and a structure, such as a polygonal structure or a hexagonal structure, and surrounding said battery cell in a plane transverse to a longitudinal axis of said battery cell. The encapsulated battery cell further includes an insulating material located in a space between said structure and said battery cell. Said insulating material has a relatively low thermal conductivity of less than 0.3 W/(m*K) at 800° C. Said structure is made from a heat distributing material having a relatively high thermal conductivity of more than 150 W/(m*K) at 25° C. In one example, a battery cell arrangement is disclosed with a plurality of such encapsulated battery cells contained in a meta structure (e.g., honeycomb) made from said heat distributing material.

### CROSS-REFERENCE TO RELATED APPLICATIONS

This application claims priority from European Patent Application No. EP23163590.5, filed Mar. 22, 2023, the content of which is incorporated herein by reference.

### BACKGROUND

This disclosure relates to an encapsulated battery cell and a battery cell arrangement comprising a plurality of encapsulated battery cells. Battery cells, such as lithium-ion battery cells, can go into thermal runaway (TR) due to external influences or internal faults, during which they may release large amounts of heat, gases, and debris. In order to limit the potentially dangerous effects of such an event, in particular when used onboard of an aircraft, some form of thermal runaway containment of the battery cells is required.

US 2017/271643 A1 proposes to place battery cells into compartments within a honeycomb element that is divided into two equally shaped parts with different heights, the longer one of which functions as a battery separating element to prevent short circuits. Said element is assumed to be made from an electrically insulating plastics material, such as PC, ABS, PP, PE, PET or PA, and suffers from the fact that it lacks thermal conductivity and is of rather high weight.

CN 214153004 U discloses encapsulated battery cells contained in a honeycomb structure. Between said honeycomb structure and the actual battery cell is located a heat absorption layer followed by, in a radial direction, a barrier explosion proof material, a cooling layer and a heat insulation.

In this approach, said heat absorption layer requires a material with high heat capacity, like a phase change material, which presents the disadvantage of rather high weight. Furthermore, said barrier explosion proof material, due to its hexagonal shape, presents a poor geometry to prevent battery explosion. If the material in said heat absorption layer is not stiff enough, the battery cell can induce a sidewall rupture which will impact the explosion proof material that is likely to fail unless a huge amount of material or a material with high strength retention is used, which will make the overall solution overweighted and not suitable for electric mobility, especially for aircraft. Furthermore, the outermost material is described as a heat insulation which is disadvantageous for preventing thermal runaway.

US 2013/183566 A1 discloses architectures of battery cells arrangements with special components that are designed to remove heat as fast as possible from the battery cells to the atmosphere. These components are described to be made of graphite which can be extruded, laminated and/or compressed and shall have an in-plane thermal conductivity of at least 150 W/(m*K), depending on the manufacturing method.

The different architectures proposed in US 2013/183566 A1 are intended to be used for thermal management during normal operation in contrast to a thermal runaway emergency condition. All the configurations shown present a highly conductive material in direct contact with the battery cell which may be counterproductive to preventing thermal runaway propagation as it will spread excess heat too fast, such that neighboring battery cells reach critical temperatures thus inducing a thermal runaway cascade.

### SUMMARY

The techniques of this disclosure provide an encapsulated battery cell for use in a battery cell arrangement, in particular for electric mobility, especially in an aircraft, that is lightweight, easy and cheap to manufacture, and which presents enhanced capabilities to prevent thermal runaway propagation. Furthermore, it is an object of the present disclosure to provide a battery cell arrangement with enhanced thermal runaway propagation prevention capabilities, especially for use onboard an aircraft. These objects are achieved by means of an encapsulated battery cell and by means of a battery cell arrangement as provided in this specification and as defined in the claims.

According to a first aspect of the disclosure, an encapsulated battery cell, comprises: a battery cell of cylindrical shape; a structure, preferably a polygonal structure, most preferably a hexagonal structure, surrounding said battery cell in a plane transverse to a longitudinal axis of said battery cell; an insulating material located in a space between said structure and said battery cell; wherein said insulating material has a relatively low thermal conductivity of less than 0.3 W/(m*K) at 800° C.; and wherein said structure is made from a heat distributing material having a relatively high thermal conductivity of more than 150 W/(m*K) at 25° C.

In general, to achieve good packing efficiency, the battery cells (or “cells”) in battery pack applications are arranged preferably in a staggered manner. A honeycomb or hexagonal arrangement is a shape or form that provides ideal bordering for heat transfer purposes in staggered applications, creating equal distance of a common cell border between neighboring cells. Due to the efficiency of this shape or form both in mechanical and thermal applications along with its high market availability makes these hexagonal structures the preferred structures in the context of the present disclosure. However, the disclosure is not limited to such shapes or configurations. Other forms such as (regular) polygons or semi-circles may also be used, as long as they provide said heat distributing material around each one of the battery cells.

According to a second aspect of the disclosure, a battery cell arrangement, comprises a plurality of encapsulated battery cells according to said first aspect of the disclosure, which battery cells are arranged side by side on a common plane, with parallel longitudinal axes, wherein a plurality of said encapsulated battery cells, preferably all of said plurality of battery cells, are arranged in a meta structure, preferably a polygonal structure, most preferably a honeycomb structure, that consists of interconnected respective structures (e.g., hexagonal structures) of individual battery cells.

The prior art cited above tries to manage thermal runaway temperature loads with one single thermal conductance mechanism. This single conductance mechanism impacts the neighboring cells in a uniform manner affecting firstly and mostly the cells in the direct vicinity of the thermal runaway spot, which cells may suffer from said temperature loads and go into thermal runaway themselves, which should be avoided.

The basic idea underlying the present disclosure deploys two different heat conductance mechanisms via two principal elements, i.e., said conductive structure, preferably of honeycomb of hexagonal shape, which is preferably made, e.g., of pure aluminum or any other material with a thermal conductivity of at least 150 W/(m*K) at 25° C., preferably 230 W/(m*K) at 25° C., and an insulating material, e.g., an aerogel, an intumescent paint or any other material with thermal conductivity of less than 0.3 W/(m*K) at 800° C., preferably less than 0.02 W/(m*K) at 25° C. A magnitude of the respective thermal conductance ratio is proportional to a thickness and conductivity of the heat carrying materials, which leaves room for performance versus weight trade-offs.

The first thermal conduction mechanism, i.e., the one to describe the flow of heat through the boundaries of the battery cells, is of higher resistance and is defined by the insulating material. The second thermal conduction mechanism, i.e., the one to describe the flow of heat in the distribution network (e.g., the honeycomb structure), is of lower resistance and is defined by the highly conducting heat distributing material (e.g., by the honeycomb or hexagonal structure, which functions as a heat distributor).

The high resistance heat diffusion mechanism ensures that any high temperature heat load of a battery cell in a thermal runaway condition (temperatures ranging from 200° C. up to 800° C.) is travelling slowly out of the malfunctioning battery cells, thus delaying the neighboring battery cells to reach critical temperatures. Here and in the following, “neighboring” shall refer to battery cells that are adjacent (or at least close) to a battery cell in thermal runaway (“triggered cell” or “TR cell”). For aircraft applications, the proposed solution offers enough time for continued safe flight and landing following a thermal runaway event. The low resistance heat diffusion mechanism rapidly distributes a lower temperature heat load (ranging from 80° C. to 200° C.) away from the impacted region and hence allows an exchange of energy with those battery cells in the arrangement (or pack) that are still at even lower temperatures.

With the above mechanism, the battery cells directly next to a thermal runaway region experience lower temperature than in the previous art. An amount of thermal energy that would have caused a critical local temperature in the vicinity of the affected battery cell(s) in all the previous art, can slowly be transferred to battery cells farther away, which will increase their respective temperatures significantly, but not to a critical level.

Furthermore, the components of the proposed encapsulated battery cell and the battery cell arrangement can be manufactured easier than in the prior art and have lower cost of procurement and processing. For example, the aluminum honeycomb structures used in preferred embodiments of the disclosure can easily be manufactured by expansion or extrusion methods for smaller thickness values, for example 0.1 mm thickness, which makes them significantly less expensive than the irregular shapes and/or graphite materials used in the prior art.

The following embodiments of the disclosure have proven to be particularly advantageous:

In an embodiment of the encapsulated battery cell according to said first aspect of the disclosure, the battery cell is enclosed in an anti-rupture container, which container is located between the battery cell and said insulating material.

Such a container may be required if the battery cell (in short also referred to as “cell”) is not able to prevent sidewall rupture by itself to prevent catastrophic events. Preferably, such an anti-sidewall rupture container is made of a high stress retention (high strength at high temperature) anti-sidewall rupture tube, although other forms may be used as well.

In a further embodiment of the encapsulated battery cell according to said first aspect of the disclosure, said container is made from Carbon Fiber Reinforced Plastic, CFRP, or Ceramic Fibric Reinforced Plastic, CerFRP, via pull-winding, prepreg wrapping or braidtrusion, in particular in the form of a tube, as stated, wherein preferably a pullwinding tube has a filament angle of up to 10° in relation to a circumferential direction of the tube and a braidtrusion tube has an angle of at most 35° in relation to a circumferential direction of the tube.

The above conditions preferably apply to a tube of at least 0.2 mm thickness per each 21 mm of tube diameter, and 30 kJ of radial heat release. Hence, the bigger the diameter and/or the greater the heat release, the bigger the preferred thickness.

In a further embodiment of the encapsulated battery cell according to said first aspect of the disclosure, the battery cell is in operative contact with a phase change material, PCM, preferable a low temperature phase change material, LTPCM, that changes phase from solid to liquid between 25° C. and 55° C., most preferably at around 45° C.

Said PCM is preferably a non-flammable, most preferably inorganic material which changes phase from solid to liquid at a temperature below the maximum working temperature recommended by the cell manufacturer and above the operational starting temperature of the cells, i.e., of each individual battery cell, which cells are typically of identical type.

An LTPCM will typically and preferably liquefy at around 45° C., which is a standard battery operating temperature. The battery cells used by the applicant should not exceed 80° C. If the temperature exceeds this limit, thermal runaway may be imminent. If TR occurs, the heat load at elevated temperatures (more than 200° C.) will no longer be managed with the PCM but with the proposed insulation/distribution function according to the above-defined basic idea of the present disclosure.

If the ambient (initial) temperature is, e.g., 25° C. and the maximum operational allowed temperature of the cell is, e.g., 55° C., the phase change should preferably happen somewhere in between those values (e.g., at 45° C.). If it happened below 25° C. or above 55° C. then it would occur out of the cell's operational window, which should be avoided. This motivates the above choice of PCM phase changing temperature.

In a further embodiment of the encapsulated battery cell according to said first aspect of the disclosure, the PCM is positioned at a bottom of the battery cell, preferably opposite to the battery cell's positive pole.

Ideally, the PCM is positioned at the bottom of the cells to stop the temperature increase such that the temperature measured at the top of the cell, resulting of a temperature gradient across the cell, does not exceed the manufacturer's recommendation.

In a further embodiment of the encapsulated battery cell according to said first aspect of the disclosure, the PCM is contained by a protection layer or protection film, e.g., silicone, that remedies any corrosive properties of the PCM, wherein preferably the PCM and the protection layer are combined in a common matrix material, e.g., by way of macro encapsulation. Said macro encapsulation can be of a silicone or epoxy compound solid enclosure (non-electrically conductive, high thermally conductive material) forming a container, in which the PCM resides, thus keeping it from flowing away while melted.

This allows for easier manufacture and can avoid any potentially detrimental effect of the PCM on the other battery components.

In a further embodiment of the encapsulated battery cell according to said first aspect of the disclosure, the insulating material has at least one of a density of less than 200 kg/m3 and a heat capacity of more than 1 kJ/(kg*K).

Such values have proven particularly well suited to achieve the desired effect.

In a further embodiment of the encapsulated battery cell according to said first aspect of the disclosure, the insulating material consists of a coating of at least one of the heat distributing material, the battery cell and the container, said coating preferably being an intumescent paint, which coating is devised to expand in volume when a temperature exceeds normal operation values above 80° C. and when expanded fills the space between said (e.g., hexagonal) structure and the cell or between said (e.g., hexagonal) structure and said container.

Such types of insulating materials are particularly lightweight and thus well suited for mobility applications, especially in aircraft.

In a further embodiment of the encapsulated battery cell according to said first aspect of the disclosure, the heat distributing material has at least one of a thickness of less than 0.7 mm, preferably less than 0.1 mm, a density of less than 3000 kg/m3 and a thermal diffusivity of more than 90 mm2/s.

A highly preferred material in this respect is aluminum.

In the context of the present disclosure, applicant has found that specific thermal conductance (W/K) along a thickness direction (i.e., not through) of the heat distributing material is dependent on the through thickness conductance of the insulating material on one of the complete inner faces of the structure, e.g., the hexagon. Hence, thermal conductance along a length of the heat distributing material should be maximized while the conductance through its thickness should be minimized.

In a specific embodiment, the relation between the thermal conductivity of the insulating material on the one hand and the heat distributing material on the other hand preferably requires that thermal conductivity and diffusivity of the heat distributing material (heat distributor, e.g., hexagonal structure or honeycomb) be sufficiently bigger than the thermal conductivity and diffusivity of the insulating material. In this way, the heat conductance of the heat distributing material (expressed in W/K) that allows heat to dissipate along any walls of the structure over a given path length (that should be at least twice long as a cell pitch or cell pitch distance, i.e., a distance between the axes of neighboring cells) can be at least twice (or more) the heat conductance through an area of a given surface region of the structure, e.g., a facet of the hexagonal structure, and over a length of the insulating material, said length being measured between the outer surface of a cell and said surface area-most preferably for each 30 kJ of energy emitted by a battery cell and per every two battery cells being triggered simultaneous in thermal runaway. This will be explained in more detail below with reference to the drawings.

In a corresponding further embodiment of the encapsulated battery cell according to said first aspect of the disclosure, the thermal conductivity and thermal diffusivity of the insulating material and the thermal conductivity and thermal diffusivity of the heat distributing material are chosen such that a thermal conductance of the heat distributing material kₕ·Aₕ/Lₕ is at least twice as big as a thermal conductance of the insulating material kᵢ·Aᵢ/Lᵢ, wherein denotes: kₕ the thermal conductivity of the heat distributing material; Aₕ an area of a cross section through the (e.g., hexagonal) structure in a radial direction with respect to said longitudinal axis of said battery cell; Lₕ a path length in the (e.g., hexagonal) structure in a plane transverse to said longitudinal axis of said battery cell; kᵢ the thermal conductivity of the insulating material; Aᵢ an area of a surface region of the structure, e.g., of one of the six facets of the hexagonal structure, facing said space; and Lᵢ a minimum distance between said battery cell or the container and said surface region/facet; wherein preferably said path length is equal to at least twice a distance between centers of neighboring said battery cells (cell pitch).

Furthermore, it is advantageously assumed that if the thermal conductance of the heat distributing material is much bigger or at least twice than the thermal conductance of the insulating material, then:
the thermal conductivity of the heat distributing material can be lowered;
the thickness of the heat distributing material (i.e., a wall thickness of the (e.g., hexagonal) structure) can be thinned;
the heat diffusivity of the heat distributing material can be lowered (i.e., heat capacity and/or density);
the thickness of the insulating material can be reduced;
the thermal conductivity of the insulating material can be increased;
the heat capacity of the insulating material can be lowered.

This can result in further weight and/or cost reduction.

In a further embodiment of the encapsulated battery cell according to said first aspect of the disclosure, a positive pole of the battery cell and a negative pole of the battery cell protrude from the insulating material and from the (e.g., hexagonal) structure, wherein preferably, for a given battery cell, the negative pole is of circular shape and surrounds the positive pole, and wherein most preferably a ring-shaped space between the negative pole and the positive pole is filled with a top insulator, in particular made from an inorganic material, preferably incorporating high temperature phase change material.

Applicant has found that such a top insulator is preferably made of a material with low thermal conductivity (for example 0.1 W/(m*K)), high heat capacity (for example 3000 J/(kg*K)), low density (for example 800 kg/m3), preferably inorganic media with high temperature phase change materials, and can serve to avoid ejecta from a neighboring triggered cell (TR cell), which may have become trapped between any additional cover elements, e.g., a lid, and the top of the cell, to transfer enough heat to induce TR propagation.

In a further embodiment of the battery cell arrangement according to said second aspect of the disclosure, said battery cell arrangement further comprises a battery enclosure with a bottom wall located below said common plane, preferably on a side opposite to the battery cells' positive poles, and with side walls that rise from said bottom wall and surround the battery cells, said enclosure most preferably made of Carbon Fiber Reinforced Plastic, CFRP, with a Glass Fiber Reinforce Plastic (GFRP) isolating film between the battery cells and the CFRP.

In a further embodiment of the battery cell arrangement according to said second aspect of the disclosure, said battery cell arrangement further comprises, for preferably each of the battery cells, a bottom venting hole located in the battery enclosure, preferably in prolongation of the longitudinal axis of a given battery cell, wherein most preferably a diameter of said venting hole measures between 20% and 60% of a cell pitch distance, which can be equal to a distance between the longitudinal axes of neighboring battery cells.

Preferably, said venting hole is big enough to allow hot gasses and flames to escape from a triggered cell in a bottom rupture event, i.e., in the case of a ruptured bottom wall of a battery cell, but small enough to affect the battery cell's structural properties only slightly, e.g., by choosing the above values.

In a further embodiment of the battery cell arrangement according to said second aspect of the disclosure, said battery cell arrangement further comprises at least one battery cell holder (for example, made from UL94-V0 plastic, or from an electrically non-conductive and inorganic (non-flammable) material, e.g., ceramic based, most preferably made of PEI, Macron or similar flame retardant or non-flammable material) in the form of a plate having a plurality of openings or through-holes, a size and location of which correspond to a size and location of the positive and negative poles of the battery cells, wherein said poles are located within said openings or through-holes.

Such a cell holder advantageously provides for a stable location of individual cells in the cell arrangement. It can be made from a high strength (for example 100 MPa tensile strength), low thermal conductivity (for example 0.1 W/(m*K)), electrically isolated material, preferably inorganic (flame retardancy preferably according to an accepted certification, e.g., UL94-V0).

In a further embodiment of the battery cell arrangement according to said second aspect of the disclosure, said battery cell arrangement further comprises an Electro Magnetic Interference, EMI, protection (for example a layer with thickness 0.02 mm-0.04 mm of copper or 0.1-0.2 mm of aluminum) at least on one side of the battery cell arrangement, preferably located on the same side as the battery cell poles, said EMI protection most preferably comprising at least one of: an electrically conductive material with attenuation greater than 60 dB for the 0.7-18 GHz frequency range; a stiffness and strength below 170 GPa and 220 MPa respectively; a thickness between 0.02 mm and 0.04 mm (copper) or between 0.1 mm and 0.2 mm (aluminum); and impregnation with an electrically conductive flame-retardant adhesive.

This allows venting of the cell's gases and ejecta during a thermal runaway while providing sufficient electromagnetic shielding.

In a further embodiment of the battery cell arrangement according to said second aspect of the disclosure, said battery cell arrangement further comprises a separator in the form a plate having a plurality of openings or through-holes, a size and location of which correspond to a size and location of the positive and negative poles of the battery cells, wherein said poles are located in respective regions of said openings or through-holes, which openings or through-holes preferably match with the openings or through-holes of the above-described battery cell holder. Said separator is preferably made from an inorganic material (for example aerogel) and preferably has at least one of a thermal conductivity below 0.3 W/(m*K) at 1000° C., a high heat capacity of 1 kJ/(kg*K) and a density below 200 kg/m3.

A preferred function of said separator is to prevent oxygen flow between the cells while allowing space for any electrical cell interconnectors to be placed and connected between the cells.

In a further embodiment of the battery cell arrangement according to said second aspect of the disclosure, said battery cell arrangement further comprises a lid, preferably from an inorganic material (for example titanium or stainless steel), which closes the battery enclosure on a top side thereof opposite said bottom wall, which lid preferably supports the above-described EMI protection.

Most preferably, the lid is made from a material with low thermal conductivity (less than 20 W/(m*K)) and/or of high strength (at least 400 MPa at 600° C.) in order to be able to withstand internal and external damaging effects.

In a further embodiment of the battery cell arrangement according to said second aspect of the disclosure, said battery cell arrangement further comprises, for preferably each of the battery cells, a top primary venting hole arranged in the lid, preferably more than 80% of a battery cell diameter in size.

This allows venting of cell gases without overmuch affecting mechanical stability.

In a further embodiment of the battery cell arrangement according to said second aspect of the disclosure, said battery cell arrangement further comprises a plurality of interconnectors, each of them connecting a given battery cell's negative pole to the positive pole of another battery cell, said interconnectors preferably made of aluminum or coated, e.g., tin coated, copper, most preferably connected to said poles by wire bonding or step-welding process with preferably ohmic, ultrasonic or laser welding techniques.

Most preferably, such interconnectors are made of highly electrically conductive (e.g., 3.5×10⁷ S/m), low density (e.g., 2700 kg/m3), corrosion-resistant connectors (for example made of aluminum) that can be connected directly between pairs of battery cells or with an intermediate step for voltage reading or similar.

In a further embodiment of the battery cell arrangement according to said second aspect of the disclosure, said battery cell arrangement further comprises a thermal shield located in a gap between said meta (e.g., honeycomb) structure and the battery enclosure, which thermal shield has further properties as defined above for the insulating material.

Said thermal shield can be made of a material with low thermal conductivity (e.g., 0.02 W/(m*K)), preferably a light density (e.g., 200 kg/m3) solid material with a high heat capacity (1 kJ/(kg*K)). Alternatively, the thermal shield can be made of a coating which respects the principles mentioned above, preferably an intumescent paint with a reaction temperature as close to 80° C. as possible, and, when expanded, fills the gap between the heat distributing material (said structure) and the battery enclosure (or housing).

In a further embodiment of the battery cell arrangement according to said second aspect of the disclosure, said battery cell arrangement further comprises a temperature and voltage Printed Circuit Board, TV-PCB, preferably a laminated plastic printed circuit board, most preferably made of FR4 material, with electrical bonds to the interconnectors for voltage balancing, which TV-PCB is preferably located in a plane orthogonal to the battery cells' longitudinal axes above the battery cells' poles.

This allows for battery operation and health status data readings such as voltage and temperature.

### BRIEF DESCRIPTION OF THE DRAWINGS

Characteristics and advantages of the disclosure will now be described by way of example in connection with the appended drawings.

FIG. 1 shows a top view of a battery cell arrangement according to the disclosure;

FIG. 2 shows a detailed perspective view of the battery cell arrangement in FIG. 1;

FIG. 3 shows a sectional view along line A-A in FIG. 1;

FIG. 4 shows a perspective view of a battery cell arrangement according to the disclosure with additional components;

FIG. 5 shows a simplified perspective view of another battery cell arrangement according to the disclosure;

FIG. 6 shows a top view of a battery cell arrangement similar to FIG. 5;

FIG. 7 shows a sectional view along line A-A of a battery cell arrangement similar to FIG. 6; and

FIG. 8 shows another top view of a battery cell arrangement similar to FIG. 5.

### DETAILED DESCRIPTION

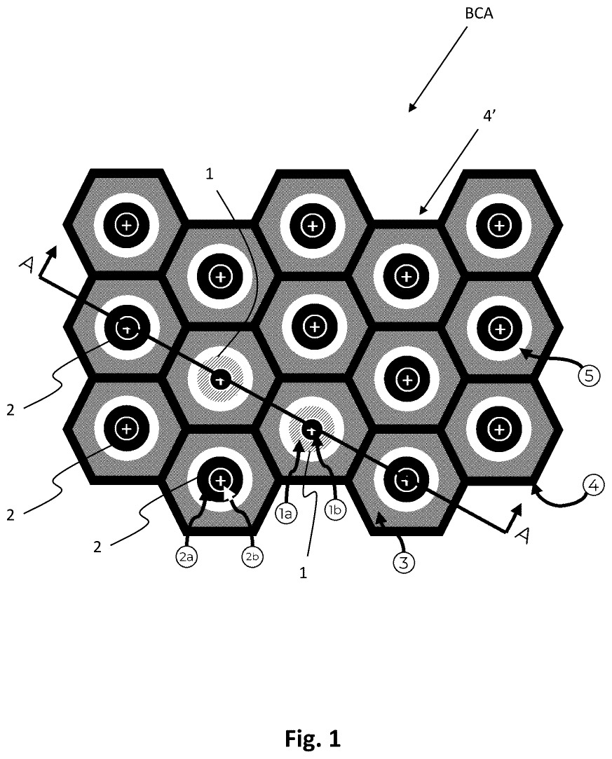

FIG. 1 is a top view of a battery cell arrangement BCA according to the present disclosure. Individual battery cells (or “cells”) in the arrangement are denoted 1, 2 and are depicted by means of filled circular areas. An open circle with a plus sign denotes a positive pole of a given cell 1, 2, whereas an area surrounding said circle denotes a negative pole of a given cell 1, 2. Assume cell 1 is a triggered cell; its negative pole is denoted 1a, and its positive pole is denoted 1b (only shown for one cell 1). Reference numerals 2a, 2b denoted respective negative and positive poles of a “normal” cell 2, which is only shown for one such normal cell 2 for reason of clarity.

Each cell 1, 2 is of cylindrical shape (longitudinal axes perpendicular to the plane of the drawing) and is surrounded by an insulating material 3, which insulating material 3 is itself located within a hexagonal structure 4 made from a heat distributing material (so-called heat distributor). The hexagonal structures 4 of the individual cells 1, 2 are interconnected and thus form a honeycomb structure 4′ (meta structure) as shown in FIG. 1. As described above, said insulating material 3 has a relatively low thermal conductivity of less than 0.3 W/(m*K) at 800° C.; and said hexagonal structure 4 is made from a heat distributing material having a relatively high thermal conductivity of more than 150 W/(m*K) at 25° C.

Battery cell arrangement BCA thus comprises a plurality of (encapsulated) battery cells 1, 2 (i.e., battery cells together with at least insulating material 3 and hexagonal structure 4), which battery cells 1, 2 are arranged side by side on a common plane, i.e., the drawing plane of FIG. 1, with parallel longitudinal axes, wherein all of said plurality of battery cells 1, 2 are arranged in said honeycomb structure 4′ that consists of interconnected respective hexagonal structures 4 of individual battery cells 1, 2.

Immediately surrounding each of the cells 1, 2 there is arranged an optional anti-sidewall rupture container 5 (white rings in FIG. 1). If the cell 1, 2 is not able to prevent sidewall rupture by itself, then the anti-sidewall rupture container 5 is preferably provided, as shown. It can be made of a high stress retention (high strength at high temperature) anti-sidewall rupture tube that extends parallel to the cell's axis. Preferably, it is made of Carbon Fiber Reinforced Plastic (CFRP) or Ceramic Fibric Reinforced Plastic (CerFRP) via pull-winding, prepreg wrapping or braidtrusion.

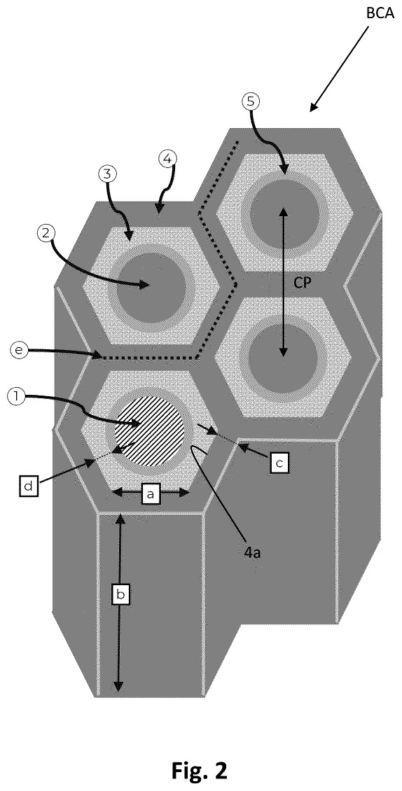

Referring now to FIG. 2, which shows a detail from FIG. 1 in a perspective view, some basic geometrical aspects shall be explained in further detail.

Please note that in all of the drawings, identical reference signs denote identical elements or elements that have at least a common function.

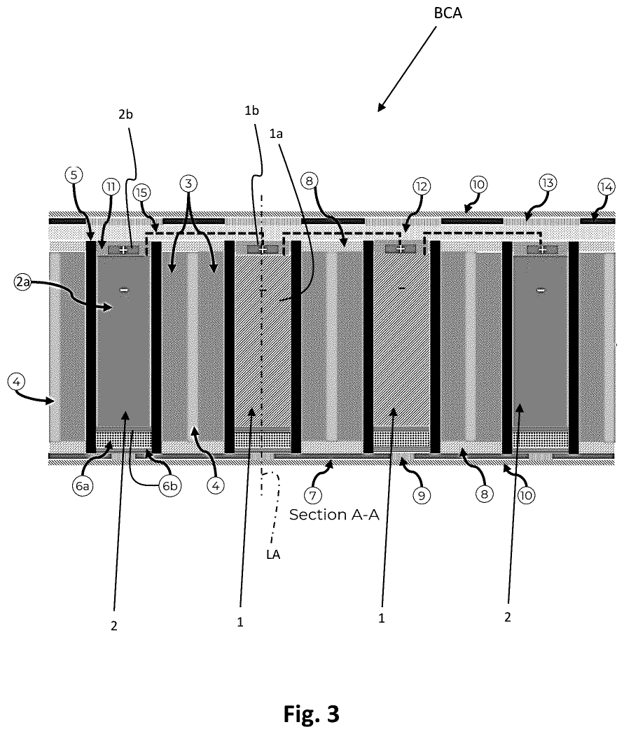

In FIG. 2, reference numeral 1 again denotes a triggered cell, while reference numeral 2 stands for a normal cell. The hexagonal structure 4 around each cell 1, 2 is regularly shaped and has six equal sides or facets 4a with width a and height b. Reference numeral c denotes a wall thickness of said facets 4a, while d is the (minimum) distance between a given cell 1, 2 (i.e., its anti-rupture container 5) and facet 4a. Reference numeral e denotes a path (shown as a dotted line) along the hexagonal structure 4 in a plane perpendicular to the cells' longitudinal axis (cf. FIG. 3), a length of which path (also denoted e for simplicity) is at least twice as long as a cell pitch CP, i.e., the distance between two neighboring cells 1, 2, measured from center to center for any pair of cells 1, 2.

As already explained in the introductory part, specific thermal conductance (unit W/K) along a thickness (not through) of the heat distributing material (in said hexagonal structure 4) is dependent on the through thickness conductance of insulating material 3 on one of the complete inner faces or facets 4a of the hexagon. Hence, the conductance along the heat distributor's length should be maximized while the conductance through its thickness should be minimized.

The relation between the thermal conductivity of the materials at 3 and 4 requires that thermal conductivity and diffusivity of the material making up the hexagonal structure 4 (heat distributor honeycomb) is sufficiently bigger than the thermal conductivity and diffusivity of insulating material 3 such that the heat conductance of the heat distributing material in hexagonal structure 4 (expressed in W/K) allows an amount of heat to flow through the cross-section c*b (also denoted Aₕ) and along said path of length e (or at least two cell pitches CP away; also denotes Lₕ), which amount should at least two times bigger than the heat flow through the cross-section a*b (also denoted Aᵢ) of facet 4a and along said length d of insulating material 3 (also denoted Lᵢ)—preferably for each 30 kJ of energy emitted by a cell 1, 2 and per every two cells being triggered simultaneous in thermal runaway (cf. cells 1 in FIG. 1).

If, as a numerical example, the thermal conductivity kₕ of the heat conducting material in hexagonal structure 4 is 0.24 W/(mm*K) and dimension c is 0.1 mm, while b is 60 mm and e is 50 mm, then the thermal conductance will be equal to kₕ·Aₕ/Lₕ, i.e., 0.03 W/K (=0.24 W/(mm*K)*(0.1*60 mm2/50 mm)).

On the other hand, if the thermal conductivity kᵢ of insulating material 3 is 0.000025 W/(mm*K) and dimension a is 11 mm, while b is 60 mm and d is 1.1 mm, then its thermal conductance will be equal to kᵢ·Aᵢ/Lᵢ, i.e., 0.015 W/K (=0.000025 W/(mm*K)*(11*60 mm2)/1.1 mm). Therefore, the thermal conductance of the heat conducting material in hexagonal structure 4 will be twice the thermal conductance of insulating material 3, as preferred.

Further details can be gathered from section A-A (cf. FIG. 1) as shown in FIG. 3.

Located below every battery cell 1, 2 are thermal management elements in the form of PCM 6a and protection film 6b, which elements are contained with rupture container 5, with protection film 6b located below and above PCM 6a. Alternatively, both elements can be combined and trapped in a single matrix (not shown).

PCM 6a is preferably a non-flammable, preferably inorganic material that changes phase from solid to liquid at a temperature below the maximum working temperature recommended by the cell manufacturer and above the operational starting temperature of the cells 1, 2. Refer to the introductory part for details.

Protection film 6b is preferably a highly conductive compound (like silicone, for example) that is compatible with the materials in contact. Protection film 6b prevents corrosion that could result from the potentially corrosive properties of the (LT)PCM 6a.

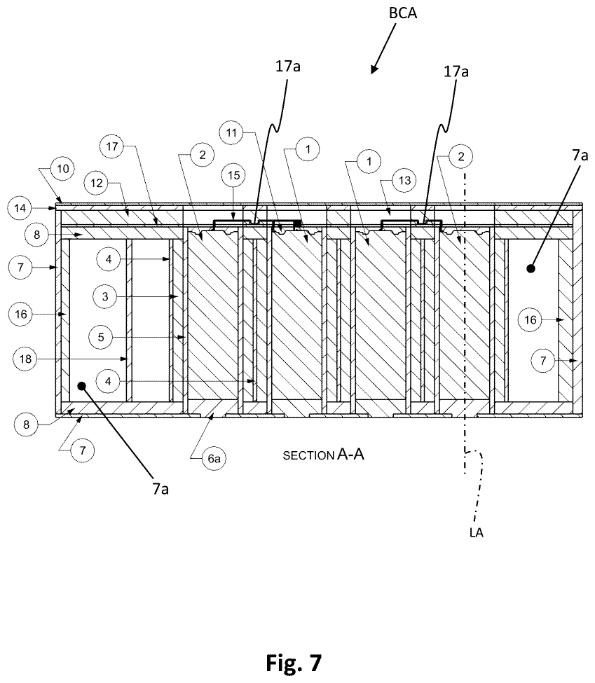

Reference numeral 7 denotes a battery enclosure or housing, which housing is preferable made of a high strength, low weight material with a balanced thermal conductivity as described above. Highly preferred materials are CFRP with a thin Glass Fiber Reinforce Plastic (GFRP) isolating film (not shown) between the cells and the CFRP. Housing 7 is not restricted to the bottom of arrangement BCA, as shown in FIG. 3, but can also cover the sides of it (cf. FIG. 7).

Reference numeral 8 denotes a (battery) cell holder made from a high strength, low thermal conductivity, electrically isolated material, preferably inorganic (flame retardancy is advantageous, e.g., UL94-V0).

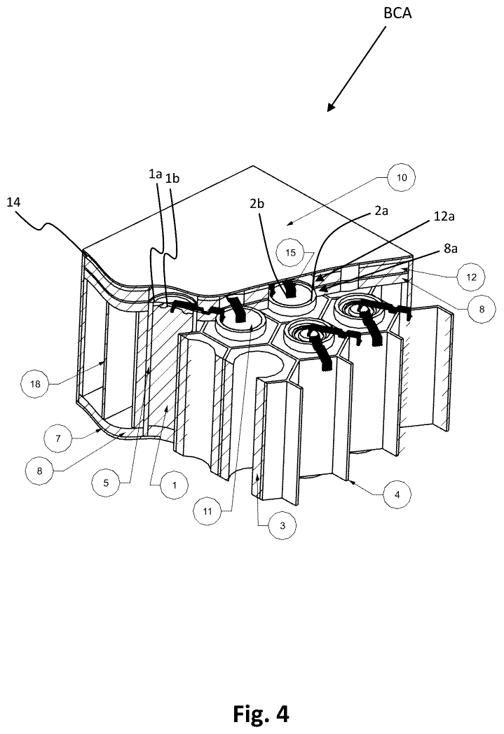

As can best be seen from FIG. 4, said battery cell holder 8 generally takes the form of a plate having a plurality of openings or through-holes 8a, a size and location of which holes 8a correspond to a size and location of the positive 1b, 2b and negative poles 1a, 2a of the battery cells 1, 2 (cf. FIG. 1), wherein said poles are located within said openings or through-holes 8a.

Back to FIG. 3, reference numeral 9 denotes a bottom venting hole. The bottom venting hole 9 is actually a set of holes in the battery enclosure 7 which is (are) big enough to allow hot gasses and flames to escape the cells 1, 2 in a bottom rupture event, but small enough to only slightly affect the battery's structural properties. Preferably, a diameter of each of said venting holes 9 is between 20% and 60% of the cell pitch distance CP (cf. FIG. 2). As can be seen, each venting hole 9 is located in prolongation of the longitudinal axis LA of a given battery cell 1, 2.

Reference numeral 10 denotes a burstable EMI protection which serves as a topmost cover for the battery cell arrangement BCA in order to allow venting of the cell's gases and ejecta during a thermal runaway while providing electromagnetic shielding. Preferably, a highly electrically conductive material with attenuation greater than 60 dB for the 0.7-18 GHz frequency range and a stiffness and strength (UTS) preferably below 170 GPa and 220 MPa, respectively, is used, which can have between 0.02 mm and 0.04 mm in thickness. This can provide enough strength to avoid finger poking into the battery pack, but is weak enough to allow easy bursting for pressure relief. Preferably, EMI protection 10 comprises an electrically conductive flame-retardant adhesive.

Reference numeral 11 denotes a top burstable insulator made from a high thermal resistance, high heat capacity, low density, preferably inorganic medium with high temperature phase change materials, to avoid ejecta from neighboring triggered cells 1, 2 to transfer enough heat to induce a TR propagation.

As can be seen from, e.g., FIG. 3 or FIG. 4, the positive pole 2b of a given battery cell 2 and the negative pole 2a of the battery cell 2 protrude from the insulating material 3 and from the hexagonal structure 4 (but not from the rupture container 5), wherein a ring-shaped space between the negative pole 2a and the positive pole 2b is filled with said top insulator 11. The same holds for battery cell 1.

Reference numeral 12 denotes a so-called suffocating and separator medium with low thermal conductivity (preferably below 0.3 W/(m*K) at 1000° C.), high heat capacity, low density (preferably below 200 kg/m3), made from inorganic material, to prevent oxygen to flow between the cells while allowing space for cell interconnectors to be placed and connected between cells 1, 2.

Said separator medium (or just “separator”) 12 can take the form of a plate having a plurality of openings or through-holes 12a as can best be seen from FIG. 4, a size and location of which holes correspond to a size and location of the positive and negative poles of the battery cells 1, 2, wherein said poles are located in respective regions of said openings or through-holes, which openings or through-holes 12a match with the openings or through-holes 8a of the battery cell holder 8.

Referring again to FIG. 3, reference numeral 13 denotes a top primary venting hole, which is a hole on lid 14, preferably as big as possible without compromising a mechanical stability of the lid 14, preferably measuring more than 80% of the diameter of a battery cell 1, 2. There is one top venting hole 13 per battery cell 1, 2.

Lid 14 is made of high thermal resistance, high strength, preferably inorganic material and is used to cover the battery cell arrangement BCA by closing battery enclosure 7 and to hold the burstable EMI protection 10 mentioned earlier.

Reference numeral 15 denotes the electrical cell interconnectors (dashed lines in FIG. 3; cf. also FIG. 4) mentioned earlier. Said interconnectors 15 are highly electrically conductive, low weight, corrosive resistant connectors. Preferably made of aluminum or coated copper, they are connected between a given cell's negative pole, e.g., 2a, to a next cell's positive pole, e.g., 1b. There can be an intermediate step for voltage reading or similar (not shown in FIG. 3). Preferably, the interconnectors 15 are devised by wire bonding or a step-welding process with ohmic, ultrasonic or laser welding techniques. They pass within corresponding recesses of separator 12, as mentioned (cf. FIG. 4).

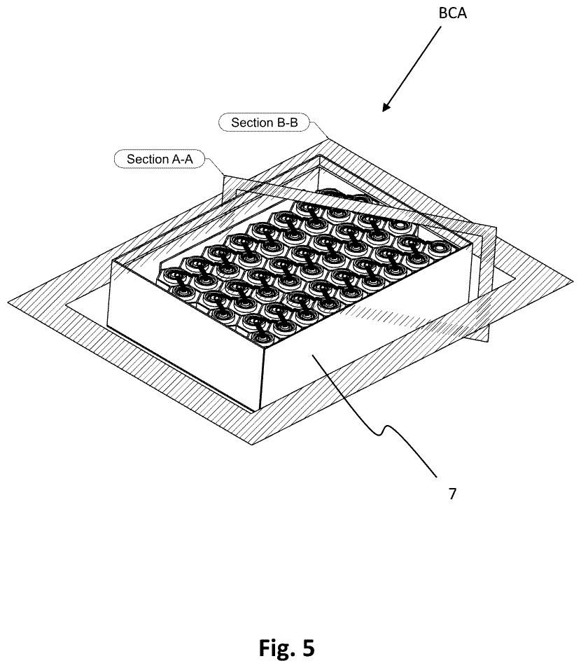

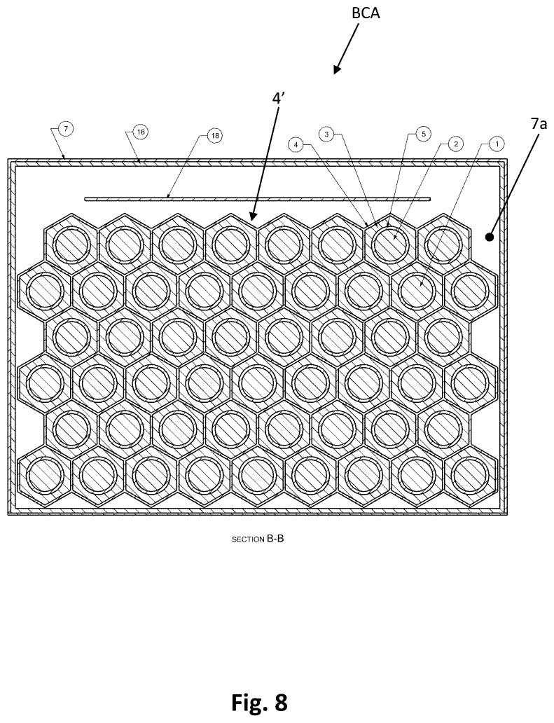

FIG. 5 shows a perspective view of battery cell arrangement BCA with enclosure 7. Section A-A is shown FIG. 7, while section B-B is depicted in FIG. 8.

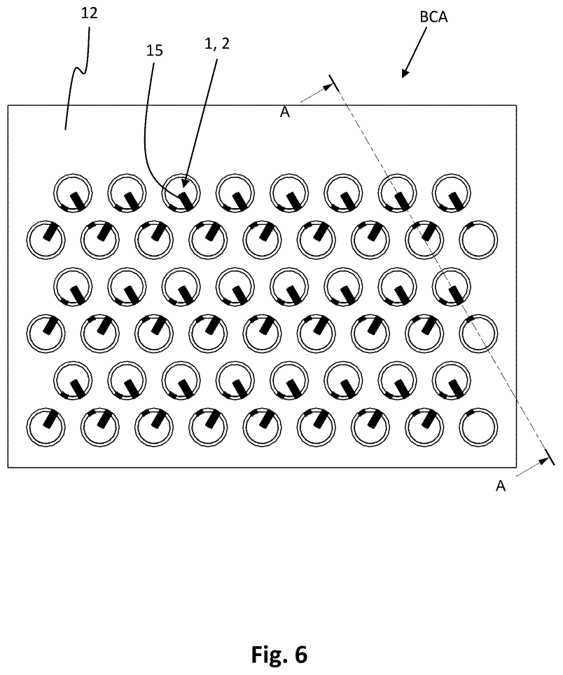

FIG. 6 shows a battery cell arrangement similar to FIG. 5 in a top view with cell holder 8 and separator 12 in place (cf. FIGS. 3 and 4).

FIG. 7 further shows, at reference numeral 16, a so-called thermal shield. Thermal shield 16 can be a low thermal conductivity, light weight solid medium, preferably with a high heat capacity, and is provided as a cladding at least of an interior face of side walls of enclosure 7. Alternatively, the thermal shield 16 can be made of a coating of an inner side of enclosure 7, which coating respects the principles mentioned above, preferably an intumescent paint that reacts when the temperature elevates to thermal runaway initiation levels and, when expanded, fills a gap or space 7a between the heat distributor (hexagonal structure 4) and housing (enclosure) 7.

In other words: thermal shield 16 is located in said gap 7a between said honeycomb structure 4′ (cf. FIG. 1 or FIG. 8) (hexagonal structure 4) and the battery enclosure 7, which thermal shield 16 has further properties as defined above for the insulating material 3.

Further visible in FIG. 7 is Temperature and Voltage Printed Circuit Board (TV-PCB) 17. This laminated plastic printed circuit board is preferably made of FR4 material and has electrical bonds with the interconnectors 15 for voltage balancing (cf. reference numeral 17a). It is located between cell holder 8 and separator 12 on top of insulator 11.

At reference numeral 18, FIGS. 7 and 8 show a Cell Management Unit Printed Circuit Board (CMU-PCB). This laminated plastic printed circuit board, preferably made of FR4 material, is mechanically attached to the cell holder(s) 8. As can be seen from the drawings, CMU-PCB 18 is located in a plane parallel to the battery cell's longitudinal axes.

The CMU-PCB allows to host various sensitive electronic components such as chipsets, cabling and control boards vital for the battery management and operation.

What is claimed is:

1. An encapsulated battery cell, comprising:
a battery cell of cylindrical shape;
a structure surrounding said battery cell in a plane transverse to a longitudinal axis (LA) of said battery cell; and
an insulating material located in a space between said structure and said battery cell,
wherein said insulating material has a relatively low thermal conductivity of less than 0.3 W/(m*K) at 800° C., and
wherein said structure is made from a heat distributing material having a relatively high thermal conductivity of more than 150 W/(m*K) at 25° C.

2. The encapsulated battery cell of claim 1, wherein
the battery cell is enclosed in an anti-rupture container that is located between the battery cell and said insulating material.

3. The encapsulated battery cell of claim 2, wherein
said anti-rupture container is made from Carbon Fiber Reinforced Plastic (CFRP) or Ceramic Fibric Reinforced Plastic (CerFRP) and in a form of a tube.

4. The encapsulated battery cell of claim 3, wherein
said anti-rupture container is made in the form of the tube via pull-winding, and
a pullwinding tube has a filament angle of up to 10° in relation to a circumferential direction of the tube and a thickness of the tube is at least 0.2 mm.

5. The encapsulated battery cell of claim 3, wherein
said anti-rupture container is made in the form of the tube via prepreg wrapping or braidtrusion, and
a braidtrusion tube has an angle of at most 35° in relation to a circumferential direction of the tube and a thickness of the tube is at least 0.2 mm.

6. The encapsulated battery cell of claim 1, wherein
the battery cell is in operative contact with a phase change material (PCM) or a low temperature phase change material (LTPCM) that changes phase from solid to liquid between 25° C. and 55° C.

7. The encapsulated battery cell of claim 6, wherein
the PCM is at least one of:
positioned at a bottom of the battery cell opposite to a positive pole; and
contained by a protection layer or protection film that remedies corrosive properties of the PCM.

8. The encapsulated battery cell of claim 7, wherein
the PCM and the protection layer are combined in a common matrix material.

9. The encapsulated battery cell of claim 1, wherein
the insulating material comprises at least one of a density of less than 200 kg/m3 and a heat capacity of more than 1 kJ/(kg*K).

10. The encapsulated battery cell of claim 1, wherein
the insulating material consists of a coating of at least one of the heat distributing material,
said coating comprises an intumescent paint and is devised to expand in volume when a temperature exceeds normal operation values above 80° C. and when expanded fills the space between said structure and the encapsulated battery cell.

11. The encapsulated battery cell of claim 1, wherein
the heat distributing material has at least one of a thickness of less than 0.7 mm, a density of less than 3000 kg/m3, and a thermal diffusivity of more than 90 mm2/s.

12. The encapsulated battery cell of claim 1, wherein
the heat distributing material is denoted as kₕ·Aₕ/Lₕ,
the relatively low thermal conductivity and thermal diffusivity of the insulating material and the relatively high thermal conductivity and thermal diffusivity of the heat distributing material are chosen such that a thermal conductance of the heat distributing material is at least twice as big as a thermal conductance of the insulating material that is denoted as kᵢ·Aᵢ/Lᵢ,
kₕ denotes the thermal conductivity of the heat distributing material,
Aₕ denotes an area of a cross section through the structure in a radial direction with respect to said longitudinal axis (LA) of said battery cell,
Lₕ denotes a path length (e) in the structure in a plane transverse to said longitudinal axis (LA) of said battery cell,
kᵢ denotes the thermal conductivity of the insulating material,
Aᵢ denotes an area of one of a surface region of the structure facing said space, and
Lᵢ denotes a minimum distance between said battery cell and said surface region.

13. The encapsulated battery cell of claim 12, wherein
said path length is equal to at least twice a cell pitch distance (CP) between centers of neighboring battery cells.

14. A battery cell arrangement (BCA), comprising:
a plurality of encapsulated battery cells that are arranged side by side on a common plane with parallel longitudinal axes (LA),
wherein at least two of said encapsulated battery cells are arranged in a meta structure that consists of interconnected respective structures of individual battery cells.

15. The battery cell arrangement (BCA) of claim 14, wherein
the interconnected respective structures of individual battery cells comprise a polygonal structure or a honeycomb structure.

16. The battery cell arrangement (BCA) of claim 14, further comprising:
a battery enclosure;
for each of the encapsulated battery cells at least one of:
a bottom venting hole located in the battery enclosure in prolongation of a longitudinal axis (LA) of a given battery cell, wherein a diameter of said venting hole measures between 20% and 60% of a cell pitch distance (CP) that is equal to a distance between the longitudinal axes (LA) of neighboring battery cells; and
a top primary venting hole arranged in the battery enclosure or in a lid for closing the battery enclosure, said top primary venting hole being more than 80% of a battery cell diameter in size.

17. The battery cell arrangement (BCA) of claim 14, further comprising:
at least one battery cell holder in a form of a plate having a plurality of openings or through-holes,
a size and location of the openings or through-holes correspond to a size and location of positive poles and negative poles of the battery cells, respectively, wherein said positive poles and said negative poles are located within said openings or through-holes.

18. The battery cell arrangement (BCA) of claim 14, further comprising:
a burstable Electro Magnetic Interference (EMI) protection at least on one side of the battery cell arrangement (BCA), said EMI protection comprising at least one of:
an electrically conductive material with attenuation greater than 60 dB for a 0.7-18 GHz frequency range;
a stiffness and strength below 170 GPa and 220 MPa, respectively;
a thickness between 0.02 mm and 0.2 mm; or
impregnation with an electrically conductive flame-retardant adhesive.

19. The battery cell arrangement (BCA) of claim 14, further comprising:
a separator in a form of a plate having a plurality of openings or through-holes, a size and location of the openings or through-holes corresponding to a size and location of positive poles and negative poles of the encapsulated battery cells, respectively,
wherein said positive poles and said negative poles are located in respective regions of said openings or through-holes, said separator is made from an inorganic material having at least one of a thermal conductivity below 0.3 W/(m*K) at 1000° C., a high heat capacity of more than 1 kJ/(kg*K), or a density below 200 kg/m3.

20. The battery cell arrangement (BCA) of claim 14, further comprising:
a thermal shield located in a gap between said meta structure and a battery enclosure.
